(19) United States
(12) Patent Application Publication
(10) Pub. No.: US 2010/0269822 A1
(43) Pub. Date: Oct. 28, 2010

(54) Quick Release Connector

(75) Inventor: Chih-Cheng Shiue, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: QBAS CO., LTD., Taipei (TW)

(21) Appl. No.: 12/764,274

(22) Filed: Apr. 21, 2010

(30) Foreign Application Priority Data
Apr. 24, 2009 (TW) 98113621
Apr. 21, 2010 (TW) 99112782

(51) Int. Cl. A62B 9/04

(52) U.S. Cl. 128/202.27

(57) ABSTRACT

A quick release connector joining a snorkel and a strap is provided. The quick release connector comprises a first fixing member and a second fixing member. The first fixing member comprises a fixing ring and an embedded portion. The fixing ring is adapted to encircle the snorkel. The second fixing member comprises a fixation clip, a pressing portion, and a buckle portion. The fixation clip is adapted to be clamped to the strap, and the pressing portion and the buckle portion are adapted to join together to receive the embedded portion. Thereby, the snorkel and the strap are joined for the connection between the first fixing member and the second fixing member.

This application claims priorities to Taiwan Patent Application No. 098113621 filed on Apr. 24, 2009 and Taiwan Patent Application No. 099112482 filed on Apr. 21, 2010, the disclosure of which are incorporated by reference herein in their entirety.

### CROSS-REFERENCES TO RELATED APPLICATIONS

Not applicable.

### BACKGROUND OF THE INVENTION

1. Field of the Invention

The present invention relates to a quick release connector, and more particularly, to a quick release connector for use in diving activities to join a snorkel and a strap.

2. Descriptions of the Related Art

Recreational water sports, such as diving and swimming, have gained popularity over the years, especially during the summer months. To breathe under water, snorkels have become indispensable for snorkeling. With the aid of a snorkel, even beginners who are not good at swimming can enjoy snorkeling.

When using a snorkel in the water, the user usually joins the snorkel to the strap of the diving mask and allows a portion of the snorkel to extend above the water to prevent entry of water into the snorkel and maintain smooth air exchange. Generally, the snorkel is joined to the strap through a standard clip for the user to attach and detach the snorkel more easily.

As a kind of the standard clip, a side clip structure for a snorkel has been disclosed in Taiwan Patent Publication No. 560504. This side clip structure allows the user to join the snorkel and the strap together quickly during diving and to detach the snorkel from the strap also quickly after diving, thereby providing the user an easier way to join the snorkel and the strap. However, although the side clip structure allows for a quick attachment, the snorkel can be detached only when rotated to a particular orientation. In addition, the side clip structure comprises a large number of elements and requires a complex assembling process, which drives the production cost higher and makes the structure more likely to fail.

In view of this, it is highly desirable in the art to provide a quick release connector, which has a low cost, low failure rate and high joining strength and can also be assembled and detached easily to allow for the quick joining and detachment of the snorkel from the strap.

### SUMMARY OF THE INVENTION

An objective of the present invention is to provide a quick release connector. By reducing the number of elements of the quick release connector, the production cost is lowered, and by use of an easier assembling process, the failure rate of the quick release connector is decreased, thereby prolonging the service life thereof. Thus, the user may join the snorkel to the strap more easily during diving and detach the snorkel from the strap easily after the diving sport ceases.

The present invention provides a quick release connector adapted for joining a snorkel and a strap, which comprises a first fixing member and a second fixing member. The first fixing member comprises a fixing ring and an embedded portion. The fixing ring is adapted to encircle the snorkel. The second fixing member comprises a fixation clip, a pressing portion and a buckle portion. The fixation clip is adapted to be clamped to the strap. The pressing portion has a first longitudinal opening, while the buckle portion has a vertical opening, a second longitudinal opening and a flexible pushing element. The pressing portion is disposed in the vertical opening and moves vertically relative to the buckle portion. When the pressing portion is pressed to move vertically to the first position, the first longitudinal opening and the second longitudinal opening are adapted to receive the embedded portion. When the pressing portion is released, the flexible pushing element pushes the pressing portion to a second position vertically to clamp the embedded portion in the first longitudinal opening and the second longitudinal opening.

The present invention further provides a quick release connector adapted for joining a snorkel and a strap, which also comprises a first fixing member and a second fixing member. The first fixing member comprises a fixing ring and an embedded portion. The fixing ring is adapted to encircle the snorkel. The second fixing member comprises a fixation clip, a pressing portion and a buckle portion. The fixation clip is adapted to be clamped to the strap.

The pressing portion has a first opening opened along a first direction, while the buckle portion has a second opening opened along a second direction, a third opening opened along the first direction and a flexible pushing element. The pressing portion is disposed in the second opening and moves vertically relative to the buckle portion. When the pressing portion is pressed to move vertically to the first position, the first opening and the third opening are adapted to receive the embedded portion. When the pressing portion is released, the flexible pushing element pushes the pressing portion to a second position vertically to clamp the embedded portion in the first opening and the third opening.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of a quick release connector of the present invention;

FIG. 2A is a schematic view of a pressing portion in a second fixing member of the quick release connector of the present invention;

FIG. 2B is a schematic view of a buckle portion in a second fixing member of the quick release connector of the present invention;

FIG. 3A is a schematic view of the pressing portion of the quick release connector of the present invention at a first position;

FIG. 3B is a cross-sectional view of the pressing portion of the quick release connector of the present invention at the first position;

FIG. 4A is a schematic view of the pressing portion of the quick release connector of the present invention at a second position;

FIG. 4B is a cross-sectional view of the pressing portion of the quick release connector of the present invention at the second position; and

FIG. 5 is a schematic view of another embodiment of a quick release connector of the present invention.

### DESCRIPTION OF THE PREFERRED EMBODIMENT

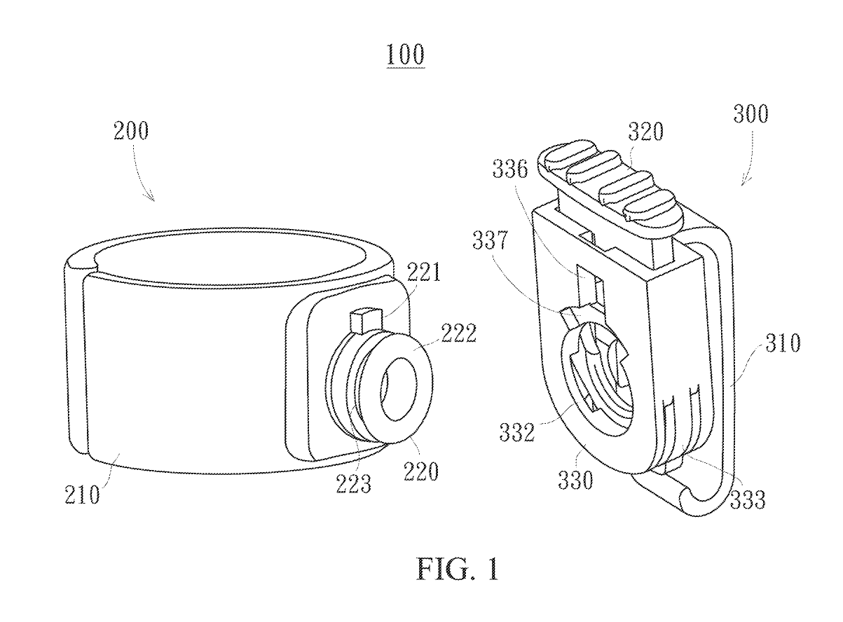

An embodiment of the present invention is a quick release connector 100 adapted for joining a snorkel (not shown) and a strap (not shown), as shown in FIG. 1. The quick release connector 100 comprises a first fixing member 200 and a second fixing member 300.

The first fixing member 200 comprises a fixing ring 210 and an embedded portion 220, in which the embedded portion 220 further comprises a projection 221. The fixing ring 210 is adapted to encircle the snorkel, and in the present invention, the fixing ring 210 is preferably a flexible C-ring which allows for snorkels of various sizes to be encircled by the C-shaped opening.

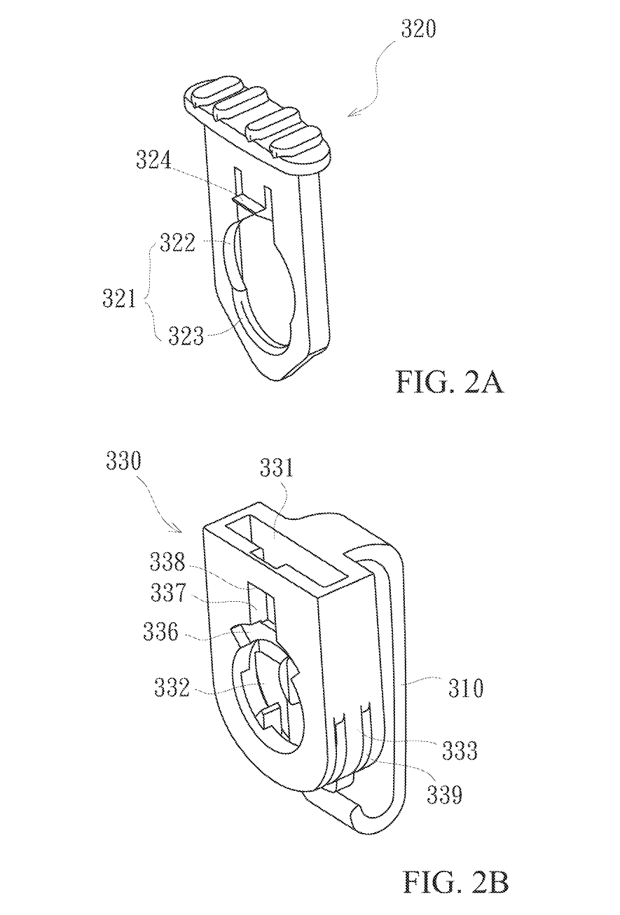

The second fixing member 300 comprises a fixation clip 310, a pressing portion 320 and a buckle portion 330. The fixation clip 310 is adapted to be clamped to the strap. As shown in FIG. 2A, the pressing portion 320 has a first opening 321 along a first direction and a hook 324. The first opening 321 has an upper portion 322 and a lower portion 323 that is slightly smaller than the upper portion 322, which seems like two partially overlapped circles. Correspondingly, as shown in FIG. 2B, the buckle portion 330 has a second opening 331 along a second direction, a third opening 332 along the first direction, a flexible pushing element 333, a recess 336 and a groove 337. The pressing portion 320 is disposed in the second opening 331 of the buckle portion 330 to move vertically relative to the buckle portion 330 between a first position 320a and a second position 320b.

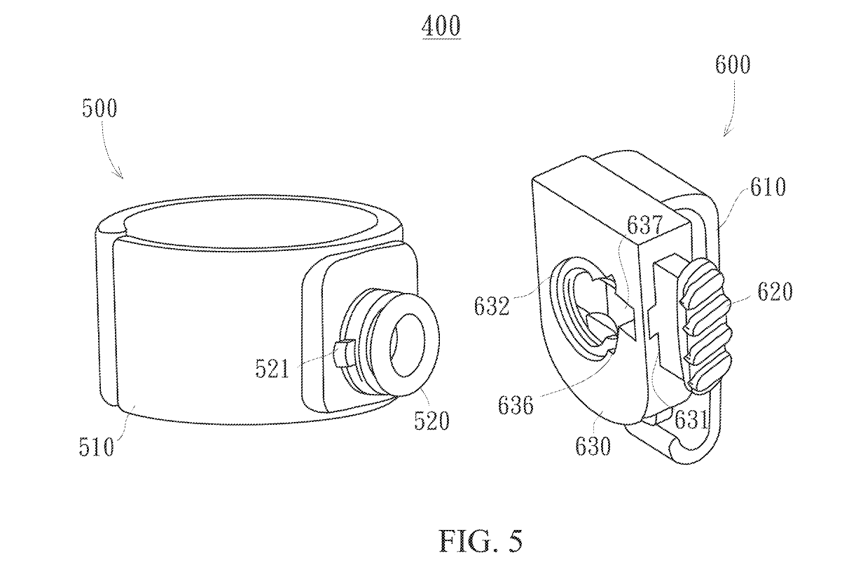

It is noted that in this embodiment, the first direction is a longitudinal direction and the second direction is a vertical direction, in other embodiments, the first direction and the second direction could be any other direction. Preferably, the first direction and the second direction are perpendicular. For example, the first direction could still be longitudinal and the second direction could be lateral in other aspects, as shown in FIG. 5. The quick release connector 400 comprises a first fixing member 500 and a second fixing member 600.

The first fixing member 500 comprises a fixing ring 510 and an embedded portion 520, in which the embedded portion 520 further comprises a projection 521. The fixing ring 510 is adapted to encircle the snorkel, and the fixing ring 510 is also preferably a flexible C-ring which allows for snorkels of various sizes to be encircled by the C-shaped opening.

The second fixing member 600 comprises a fixation clip 610, a pressing portion 620 and a buckle portion 630. The fixation clip 610 is adapted to be clamped to the strap. The pressing portion 620 has a first opening (not shown) along a longitudinal first direction. The first opening has a first portion (not shown) and a second portion (not shown) that is slightly smaller than the first portion, which seems like two partially overlapped circles. The buckle portion 630 further has a second opening 631 along a lateral direction, a third opening 632 along the longitudinal direction, a flexible pushing element (not shown), a recess 636 and a groove 637. The pressing portion 620 is disposed in the second opening 631 of the buckle portion 630 to move laterally relative to the buckle portion 630. The detailed implementation is the same as described above and further description is omitted here.

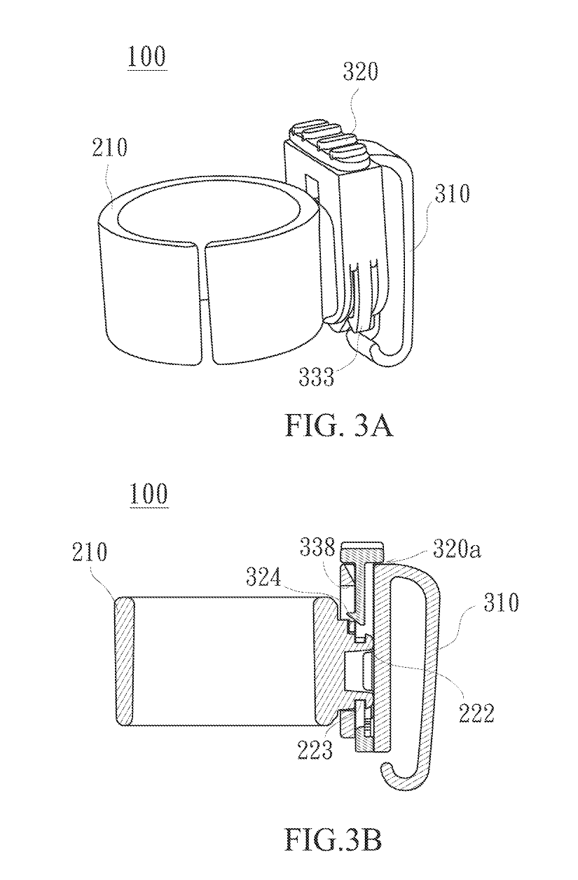

In reference to both FIGS. 3A and 3B as the embodiment of FIG. 1, when the embedded portion 220 of the first fixing member 200 is pressed by the user into the second fixing member 300, the pressing portion 320 of the second fixing member 300 will move downward vertically to the first position 320a exactly, in which case the upper portion 322 of the first opening 321 and the third opening 332 are adapted to have their axes aligned with each other and to jointly form a receiving space that receives the embedded portion 220 of the first fixing member 200.

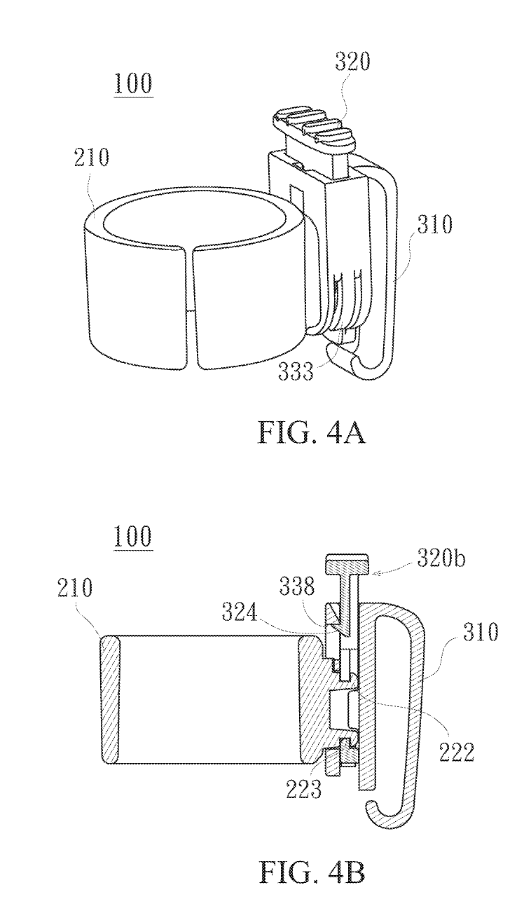

In reference to both FIGS. 4A and 4B, when the embedded portion 220 of the first fixing member 200 is embedded in the receiving space jointly formed by the upper portion 322 of the first opening 321 and the third opening 332, the flexible pushing element 333 disposed at both sides of a bottom portion 339 of the second opening 331 is adapted to push the pressing portion 320 upwards vertically to a second position 320b. At this point, the embedded portion 220 is also received in the first opening 321 and the third opening 332, but more particularly, is received in a lower portion 323 of the first opening 321 and pushed upwards by the flexible pushing element 333. Hence, when the pressing portion 320 is located at the second position 320b, the lower portion 323 of the first opening 321 is adapted to have its axis aligned with the axis of the third opening 332 such that the embedded portion 220 of the first fixing member 200 is snap-fitted in both the first opening 321 and the third opening 332 of the second fixing member 300 to be tightly fixed therein by the misalignment shearing force between the openings. In the preferred example of the present invention, the flexible pushing element 333 is a flexible foot.

The recess 336 in the buckle portion 330 of the second fixing member 300 is disposed adjacent to and above the third opening 332, and is of a curved shape with a central angle preferably ranging between 50° and 130°. When the embedded portion 220 is received in the buckle portion 330, the projection 221 is adapted to move in the recess 336. That is, when the first fixing member 200 engages with the second fixing member 300 with the embedded portion 220 being received in the buckle portion 330, the projection 221 is adapted to move in the arc-shaped recess 336 to restrain the rotation angle of the first fixing member 200 relative to the second fixing member 300.

In this embodiment, the embedded portion 220 is a column 222 with a neck portion 223 that has a smaller diameter, and the third opening 332 preferably has an inclined surface tapered inwards to guide the embedded portion 220 into the receiving space. When the embedded portion 220 is received in the buckle portion 330 with the pressing portion 320 located at the first position 320a, the upper portion 322 of the first opening 321 is adapted to have its axis aligned with the axis of the third opening 332 and is adapted to be securely engaged with at least a portion (e.g., an upper edge) of the neck portion 223. On the other hand, when the pressing portion 320 is located at the second position 320b, the third opening 332 is adapted to have its axis aligned with the axis of the lower portion 323 of the first opening 321 so that the lower portion 323 is adapted to be securely engaged with at least a portion (e.g., a lower edge) of the neck portion 223. In this way, the first fixing member 300 can be snap-fitted to and rotate relative to the second fixing member 300 without being released therefrom.

Meanwhile, to avoid the detachment of the pressing portion 320 of the second fixing member 300 from the buckle portion 330 due to an excessive vertical movement therein, the hook 324 of the pressing portion 320 is adapted to move vertically in the groove 337 of the buckle portion 330 when the pressing portion 320 moves vertically relative to the buckle portion 330. The hook 324 is adapted to be restrained to an upper edge 338 of the groove 337 when the pressing portion 320 is located at the second position 320b so that the pressing portion 320 will not detach from the buckle portion 330 due to an excessive vertical upward movement.

According to the above descriptions, the quick release connector 100 of the present invention can be assembled by simply assembling the first fixing member 300, the pressing portion 320 and the buckle portion 330 together according to the following steps: initially, the pressing portion 320 is inserted along the second opening 331 into the buckle portion 330 to form the second fixing member 300, and then the embedded portion 220 of the first fixing member 200 is pressed into a receiving space formed by the first opening 321 and the third opening 332 of the second fixing member 300, thus completing the assembly of the quick release connector 100 of the present invention.

After the embedded portion 220 of the first fixing member 200 has been pressed into the receiving space formed by the upper portion 322 of the first opening 321 and the third opening 332, the pressing portion 320 moves to the second position 320b due to the vertical upward pushing action of the flexible pushing element 333. At this point, the lower portion 323 of the first opening 321 is adapted to have its axis aligned with the axis of the third opening 332 so that the lower portion 323 of the first opening 321 is securely engaged with the lower edge of the neck portion 223 of the embedded portion 323. Due to the interaction between the projection 221 and the recess 336, the first fixing member 200 and the second fixing member 300 can rotate to a certain angle relative to each other without being released from each other.

When the pressing portion 320 is pressed to move vertically downward to the first position 320a along the second opening 331, the upper portion 322 of the first opening 321 and the third opening 332 again form a receiving space to allow for the release of the embedded portion 220 of the first fixing member 200 from the second fixing member 300 and, thus, detachment of the first fixing member 200 from the second fixing member 300. This release also simultaneously detaches the snorkel encircled by the first fixing member 200 from the strap clamped by the second fixing member 300.

Being different from the standard clip, the quick release connector 100 of the present invention provides the pushing force necessary for buckling simply by virtue of flexibility of the flexible pushing element without need of various components such as a spring. Furthermore, the first fixing member and the second fixing member are joined together by means of the shearing force resulting from the misalignment of openings. Moreover, rotation within a certain angle range in the openings facilitates the adjustment by the user as compared to the unrestrained rotation within a range of 360°. Accordingly, the quick release connector 100 of the present invention allows for the quick attachment and detachment of the snorkel and strap by use of a simpler structure, and has advantages, such as a low production and maintenance cost, low failure rate and high joining strength.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A quick release connector adapted for joining a snorkel and a strap, comprising:
a first fixing member, comprising a fixing ring and an embedded portion, and the fixing ring being adapted to encircle the snorkel; and
a second fixing member, comprising a fixation clip, a pressing portion and a buckle portion, the fixation clip being adapted to be clamped to the strap, the pressing portion having a first longitudinal opening, the buckle portion having a vertical opening, a second longitudinal opening and a flexible pushing element, the pressing portion being disposed in the vertical opening and moving vertically relative to the buckle portion;
wherein when pressing the pressing portion to move vertically to a first position, the first longitudinal opening and the second longitudinal opening are adapted to receive the embedded portion, and when releasing the pressing portion, the flexible pushing element pushes the pressing portion to a second position vertically to clamp the embedded portion in the first longitudinal opening and the second longitudinal opening.

2. The quick release connector of claim 1, wherein the first longitudinal opening has an upper portion and a lower portion, when the pressing portion is located at the first position, the embedded portion is received in the upper portion, when the pressing portion is located at the second position, the embedded portion is received in the lower portion.

3. The quick release connector of claim 1, wherein the embedded portion has a projection, and the buckle portion has a recess, and when the buckle portion receives the embedded portion, the projection is adapted to move in the recess.

4. The quick release connector of claim 3, wherein the recess is formed adjacent to the second longitudinal opening.

5. The quick release connector of claim 3, wherein the recess is a curved shape, and the central angle of the curved shape is between 50 degrees and 130 degrees.

6. The quick release connector of claim 1, wherein the embedded portion is a column having a neck portion, and the first longitudinal opening is adapted to be clamped to at least one part of the neck portion.

7. The quick release connector of claim 1, wherein the pressing portion further comprises a hook, and the buckle portion comprises a groove, when the pressing portion moves vertically relative to the buckle portion, the hook is adapted to move vertically in the groove, and when the pressing portion is located at the second position, the hook is limited by an upper edge of the groove.

8. The quick release connector of claim 1, wherein the flexible pushing elements are two flexible legs, disposed on a bottom of the vertical opening.

9. The quick release connector of claim 1, wherein the fixing ring is a C-ring.

10. A quick release connector adapted for joining a snorkel and a strap, comprising:
a first fixing member, comprising a fixing ring and an embedded portion, and the fixing ring being adapted to encircle the snorkel; and
a second fixing member, comprising a fixation clip, a pressing portion and a buckle portion, the fixation clip being adapted to be clamped to the strap, the pressing portion having a first opening opened along a first direction, the buckle portion having a second opening opened along a second direction, a third opening opened along the first direction and a flexible pushing element, the pressing portion being disposed in the second opening and moving along the second direction relative to the buckle portion;
wherein when pressing the pressing portion to move along the second direction to a first position, the first opening and the third opening are adapted to receive the embedded portion, and when releasing the pressing portion, the flexible pushing element pushes the pressing portion to a second position along the second direction to clamp the embedded portion in the first opening and the third opening.

11. The quick release connector of claim 10, wherein the first opening has an upper portion and a lower portion, when the pressing portion is located at the first position, the embedded portion is received in the upper portion, when the pressing portion is located at the second position, the embedded portion is received in the lower portion.

12. The quick release connector of claim 10, wherein the embedded portion has a projection, and the buckle portion has a recess, and when the buckle portion receives the embedded portion, the projection is adapted to move in the recess.

13. The quick release connector of claim 12, wherein the recess is formed adjacent to the third opening.

14. The quick release connector of claim 12, wherein the recess is a curved shape, and the central angle of the curved shape is between 50 degrees and 130 degrees.

15. The quick release connector of claim 10, wherein the embedded portion is a column having a neck portion, and the first opening is adapted to be clamped to at least one part of the neck portion.

16. The quick release connector of claim 10, wherein the pressing portion further comprises a hook, and the buckle portion comprises a groove, when the pressing portion moves along the second direction relative to the buckle portion, the hook is adapted to move along the second direction in the groove, and when the pressing portion is located at the second position, the hook is limited by an upper edge of the groove.

17. The quick release connector of claim 10, wherein the flexible pushing elements are two flexible legs, disposed on a bottom of the second opening.

18. The quick release connector of claim 10, wherein the fixing ring is a C-ring.

19. The quick release connector of claim 10, wherein the first direction and the second direction are perpendicular.

20. The quick release connector of claim 19, wherein the first direction is longitudinal and the second direction is vertical.

21. The quick release connector of claim 19, wherein the first direction is longitudinal and the second direction is lateral.
